(19) United States
(12) Patent Application Publication
(10) Pub. No.: US 2009/0317308 A1
(43) Pub. Date: Dec. 24, 2009

(54) Oxidation of Ammonia in Aqueous Solution to Nitrogen for Ammonia Removal

(76) Inventor: Xiaoming Ren, Menands, NY (US)

Correspondence Address: Xiaoming Ren, 13 Momrow Terrace, Menands, NY, 12204, US

(21) Appl. No.: 12/486,758

(22) Filed: Jun. 18, 2009

Related U.S. Application Data
(60) Provisional application No. 61/132,733, filed on Jun. 19, 2008.

(51) Int. Cl. B01D 53/58; B01J 23/00; B01J 21/18; B01J 23/755; B01J 21/08; B01J 29/04; B01J 27/22; B01J 27/24; B01J 23/26; B01J 23/28; B01J 23/30; B01J 23/34; B01J 23/745; B01J 23/75; B01J 23/42; B01J 23/44; B01J 23/46; B01J 23/50; B01J 23/52; B01J 23/72; B01J 23/14; B01J 23/18; B01J 23/20; B01J 23/22

(52) U.S. Cl. 422/177; 502/100; 502/180; 502/300; 502/232; 502/60; 502/177; 502/200; 502/319; 502/321; 502/305; 502/324; 502/337; 502/338; 502/339; 502/325; 502/340; 502/343; 502/345; 502/344; 502/347; 502/350; 502/352; 502/349; 502/353; 502/171; 502/102

(57) ABSTRACT

Catalysts are formulated to resemble a direct ammonia/air fuel cell at short circuit at the nanoscale level to convert ammonia in aqueous solution directly and spontaneously to nitrogen at near or above ambient temperature. The catalyst particle contains a type-A catalyst subparticles for ammonia oxidation to nitrogen, and a type-C catalyst subparticles for oxygen reduction, with the type-A and type-C catalyst subparticles electrically shorted. Advantages realized at the nanoscale level are enhanced conductances for electrons and hydroxyl anions between the neighboring type-A and type-C catalyst subparticles. With the catalysts packed and confined in a catalyst bed in a chemical reactor, the direct conversion of ammonia in an aqueous phase to nitrogen can be carried out continuously for ammonia removal from a water stream in a compact package, and without the high cost arising from constructing and maintaining a bulk electrochemical device, and without the step of exacting the ammonia into gas phase.

### CROSS REFERENCE TO RELATED APPLICATIONS

This application claims the benefit of provisional patent application Ser. No. 61/132,733 filed on Jun. 19, 2008 by the present inventor.

### FEDERALLY SPONSORED RESEARCH

Not Applicable

### SEQUENCE LISTING OR PROGRAM

Not Applicable

### BACKGROUND OF THE INVENTION

1. Field of the Invention

This invention provides catalysts for converting ammonia in an aqueous solution directly to nitrogen gas at about or above ambient temperature. It also provides a method for water treatment to lower its ammonia content by converting the ammonia to nitrogen directly in aqueous phase.

2. Prior Art

Ammonia found in aqua system at an elevated level presents health hazard. Industrial and residential waste streams containing ammonia at the elevated level need to be properly treated to lower the ammonia concentration within the legally allowable limits before being discharged.

The prior art methods in removing ammonia from the waste streams require expensive machines and use complicated procedures. For example, in one method used to remove ammonia from industrial waste streams that contain ammonium sulphate ((NH₄)₂SO_{4 (aq)}), the pH of the waste stream is raised to a value greater than 10.5 by adding sodium hydroxide to convert the ammonium (NH₄⁺_{(aq)}) into ammonia (NH₃ (aq)), and then the ammonia in solution is extracted into gas phase to gaseous ammonia. After the addition of more combustible fuel such as hydrogen, the ammonia gas is flamed in air. Because of the high temperature involved in flaming ammonia in air, pollutants such as NOₓ could be produced, posing potential damage to the environment.

Catalytic oxidation of ammonia in the gas phase with oxygen at an elevated temperature has been extensively studied. It is found that at a temperature higher than 350° C., ammonia oxidation promotes the formation of nitric oxides with a variety of catalysts, such as those revealed in U.S. Pat. No. 4,812,300, U.S. Pat. No. 5,242,882, and U.S. Pat. No. 3,853,790. To minimize the formation of nitric oxides in the gas phase ammonia oxidation reaction, U.S. Pat. No. 7,410,626 teaches the formation and use of layered catalyst containing a refractory metal oxide inner layer, a platinum middle layer and a vanadium top layer. With the layered catalyst, the catalytic oxidation of ammonia in the gas phase with an oxygen containing gas stream carried out at a temperature between 200 to 375° C. proceeds preferentially to nitrogen gas. US patent application 20070059228 revealed the formation of Pt on silica support as catalyst for converting gaseous ammonia with oxygen to nitrogen between 125 and 200° C. The Pt on silica support catalyst needs to be activated at a temperature above 125° C., while holding the reaction temperature below 200° C. to avoid the nitric oxide formation. In the above mentioned patent application, extracting ammonia into the gas phase from an aqueous solution is an energy intensive step, involving using a heater and a vaporizer.

In the commonly used method to treat the residential sewage water containing ammonia at a low level, multistep bacteria assisted biological ammonia decomposition processes are used. However, there are limitations in using the bacteria processes, such as the low level of ammonia in the waste stream allowable to the bacteria processes, and the rate of the bacteria processes being strongly affected by the ambient temperature. For this reason, the processes of ammonia decomposition by bacteria would be very difficult to carry out in the winter months compared to in the summer months.

Removal of ammonia by electrolysis using an electrochemical device has been documented in literatures (Frederic Vitse, Matthew Cooper, and G. G. Botte, “On the Use of Ammonia Electrolysis for Hydrogen Production,” J. Power Sources, 142, 18-26 (2005)) and in patents, (U.S. Pat. No. 6,083,377, U.S. Pat. No. 7,160,430 B2). In this method, the electrochemical device used to carry-out the electrolysis consists of two electrodes electrically separated by a hydroxide anion (OH⁻) conducting medium, and a DC power source connected to the two electrodes. The electrical energy input drives the ammonia electrolysis reactions. At the anodic electrode, which is connected to the positive terminal of the power supplier, ammonia is electro-oxidized to N₂ gas on the surface of the electrocatalysts, according to the following electrode reaction carried out in an alkaline medium:

2NH_{3(aq)}+6OH⁻_{(aq)}→N_{2(g)}+6H₂O_{(I)}+6e⁻ (1)

At the cathodic electrode, which is connected to the negative terminal of the power supplier, the electrical energy input drives an electro-reduction process of evolving hydrogen gas on the surface of the electrocatalysts, according to the following electrode reaction carried out in an alkaline medium:

6H₂O_{(I)}+6e⁻→6OH⁻_{(aq)}+3H_{2(g)} (2)

The combined electrode reactions of eq. (1) and (2) driven by the electrical energy input is the conversion of ammonia to nitrogen gas (N₂) and evolution of hydrogen gas (H₂):

2NH_{3(aq)}+Electrical energy→N_{2(g)}+3H_{2(g)} (3)

As the result, ammonia is removed by converting it to harmless nitrogen gas directly in aqueous solution at near ambient temperature.

To carry out the electrochemical reactions of ammonia electrolysis for removal of ammonia, several key requirements must be met for the electrochemical device, as described below:
1) using suitable catalysts incorporated in the anode electrode in order to promote the ammonia electro-oxidation reaction while avoiding any side reaction, such as oxygen evolution reaction at the anode:

6OH⁻_{(aq)}→3/2O_{2(g)}+3H₂O_{(I)}+6e⁻ (4)

and at the opposite electrode the same electro-reduction of hydrogen evolution occurs as shown in Eq. (3). The overall reaction involved with oxygen evolution is:

3H₂O_{(I)}+Electrical energy→3/2O_{2(g)}+3H_{2(g)} (5)

In such a case, the electrolysis is ineffective in converting ammonia to nitrogen gas, and the electrical energy input is wasted in splitting water to oxygen gas and hydrogen gas.
2) using electrodes with a sufficiently large area so as to provide a sufficient length of time to allow the ammonia molecules to diffuse from the bulk of solution to the surface of the catalysts incorporated in the anode;
3) requiring electronic isolation between the anode and cathode immersed in the solution phase, otherwise no electrical energy input reaches the electrodes since a shorting circuit would be formed at the contact point of the two electrodes;
4) requiring hydroxide (OH⁻) ionic conduction between the anode and cathode provided by mobile hydroxyl anions to pass the ionic current from the cathode to anode in the solution phase. This is commonly accomplished by adding a base, such as NaOH, Ca(OH)₂ or KOH, in the solution. In order to decrease the ionic resistance to the current flow so as to minimize the electrical energy consumption, it is a common practice by increasing the OH⁻ concentration and by decreasing the physical gap between the two electrodes. However, a minimum gap must be maintained in practice in order to avoid forming a short circuit between the anode and cathode;
5) maintaining the solution in alkaline conditions so that the chemical equilibrium is shifted towards ammonia in the aqueous solution:

NH₄⁺_{(aq)}+OH⁻_{(aq)}→NH_{3(aq)}+H₂O_{(I)}.
6) providing an input of electrical energy in order to drive the two electrode reactions (1) and (2) by using a DC power supplier.

It may now become obvious to those skilled in the art that to engineer such an electrochemical device for ammonia removal from aqueous streams by electrolyzing ammonia to nitrogen gas, one has to overcome significant barriers which may be too high to deem the method to be practically useful. For example, it is difficult to minimize the required area of electrodes and the space between the electrodes, resulting in a bulky electrochemical unit. Additionally, there are high costs associated with building the electrodes, maintaining and running the electrochemical device that needs electrical energy input, addition of alkaline electrolyte, and means for corrosion protections.

In viewing these difficulties of above mentioned methods of prior art in removing ammonia from aqueous streams, it is the intention of this invention to provide significant improvements in a novel approach.

### OBJECTS AND ADVANTAGES

It is an object of the invention to provide a catalyst that oxidizes ammonia directly in aqueous solution to nitrogen at about or above ambient temperature.

It is a further object of the invention to provide a process to treat an aqueous stream containing undesirable level of ammonia in a manner such that the ammonia is converted to nitrogen gas directly in aqueous phase at about or above ambient temperature.

### SUMMARY

The invention describes a novel method for removing ammonia from an aqueous solution by converting ammonia to harmless nitrogen gas directly and spontaneously at about or above ambient temperature. The ammonia containing aqueous stream is mixed with an oxygen containing stream, such as air, oxygen, or hydrogen peroxide, in a chemical reactor containing a specially formulated catalyst. When the ammonia and oxidant molecules in the mixture are exposed to the catalyst, the catalyst performs electro-oxidization of ammonia to nitrogen gas and electro-reduction of oxygen to water simultaneously. The result is a spontaneous chemical combination of the ammonia and oxidant molecules on the surface of the catalyst particles to form nitrogen and water. The ammonia conversion process on the catalyst surface resembles a miniaturized direct ammonia/oxidant fuel cell at nanoscale level operated at short circuit mode in spontaneously converting ammonia to nitrogen at the maximum rate by releasing the chemical energy stored in the ammonia molecules as waste heat. The catalysts are packed and confined in catalyst beds in a chemical reactor. The entire process of ammonia removal occurs spontaneously in the aqueous phase at a temperature significantly below that found in a combustion process or in a catalytic ammonia oxidation process in prior art technologies, and without the high cost associated with building electrodes, maintaining and running a bulky electrolysis device that needs electrical energy input.

### DRAWINGS—FIGURES

In order that the manner in which the above-recited and other advantages and objects of the invention are obtained will be readily understood, a more particular description of the invention briefly described above will be rendered by reference to specific embodiments thereof which are illustrated in the pending drawings. Understanding that these drawings depict only typical-embodiments of the invention and are not therefore to be considered to be limiting of its cope, the invention will be described and explained with additional specificity and detail through the use of the accompanying drawings in which:

FIG. 1. A direct ammonia/air fuel cell operated at room temperature with ammonia in an aqueous solution fed to cell anode and oxygen by diffusion from ambient air to cell cathode;

FIG. 2. Plots of cell voltage (left y-axis) and corresponding electrical power output (right y-axis) as a function of cell current density for a direct ammonia/air fuel cell operated at room temperature with cathode by air diffusion from ambient air;

FIG. 3A. Cell voltage at a constant current discharge rate of 10 mA/cm² for a direct ammonia/air fuel cell operated at room temperature with cathode by diffusion from ambient air. Renewed fuel returns the original fuel cell voltage after each run;

FIG. 3B. Cell current density at a cell voltage of 0.05 V for a direct ammonia/air fuel cell operated at room temperature with cathode by diffusion from ambient air. The anode compartment was fed with a 5% KOH solution containing various ammonia concentrations;

FIG. 3C. Plot of steady state current at a cell voltage of 0.05 V as a function of ammonia concentration for a direct ammonia/air fuel cell operated at room temperature with cathode by diffusion from ambient air;

FIG. 3D. Plot of steady state current at a cell voltage of 0.05 V as a function of KOH concentration while keeping a constant ammonia concentration at 1.0 wt. % for a direct ammonia/air fuel cell operated at room temperature with cathode by diffusion from ambient air;

FIG. 4. Plot of N₂ gas volume calculated according to Faraday's law against the gas volume collected from the anode compartment of a direct ammonia/air breathing fuel cell. The unit slope corresponds to an 100% conversion of ammonia to nitrogen at the anode of a direct ammonia/air fuel cell operated at various current densities;

FIG. 5A-F. A schematic diagram of a catalyst particle functioning identically as a direct ammonia/air fuel cell at nanoscale level at short circuit mode in converting ammonia to nitrogen directly in aqueous phase;

FIG. 6. A schematic diagram showing a chemical reactor as one of many possible implementations of this invention in converting ammonia to nitrogen directly in aqueous phase for water treatment to lower the ammonia level.

### DETAILED DESCRIPTIONS

Based on thermodynamics, an ammonia molecule has a high energy content. In a combustion process, ammonia molecules react with O₂ to form water and nitrogen, and heat is released:

2NH_{3(g)}+3/2O_{2(g)}→N_{2(g)}+3H₂O_{(g)}+heat (6)

In practice, ammonia and air have a very narrow composition window of flammability, and a very high ignition energy is required to start the combustion process. As the result, the addition of other fuels, such as H₂, is required to assist the combustion process of ammonia in air. Other drawbacks of flaming ammonia include the high temperature involved that tends to encourage the formation of NOₓ as air pollutants.

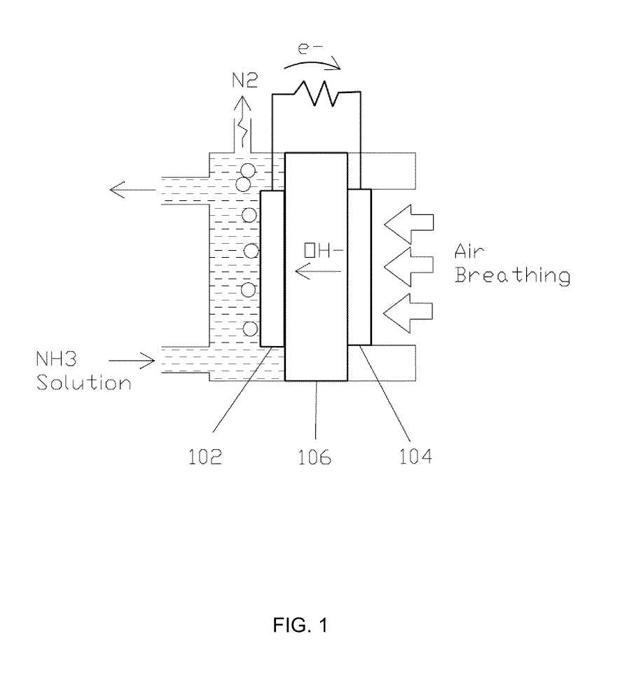

Ammonia as a fuel can be converted to N₂ at a temperature significantly below that found in the combustion process and directly in aqueous phase, as demonstrated in a direct ammonia/air fuel cell operated at room temperature. As shown in FIG. 1, in a direct ammonia/air fuel cell, ammonia as the fuel is fed to the fuel cell anode 102, and oxygen from air as the oxidant fed to the cell cathode 104, in this case, by natural diffusion of oxygen from ambient air. The cell anode 102 and cell cathode 104 is electrically separated by a hydroxide anion conducting polymer electrolyte membrane 106. The polymer electrolyte membrane 106 can be made of hydrocarbon polymer or fluorocarbon polymer containing fixed anion exchanging sites made of phosphonium, or quaternary ammonium cationic functional groups.

The electrode reaction at the fuel cell anode is ammonia electro-oxidation reaction:

2NH_{3(aq)}+6OH⁻_{(aq)}→N_{2(g)}+6H₂O_{(I)}+6e⁻ (1)

which is the same as the ammonia electrolysis anode. The electrode reaction at the fuel cell cathode is the oxygen reduction reaction:

3H₂O_{(I)}+3/2O_{2(g)}+6e⁻→6OH⁻_{(aq)} (7)

The combined reaction of these two electrode reactions, eqs. (1) and (7), is:

2NH_{3(aq)}+3/2O_{2(g)}→N_{2(g)}+3H₂O_{(I)}+electrical energy output (8)

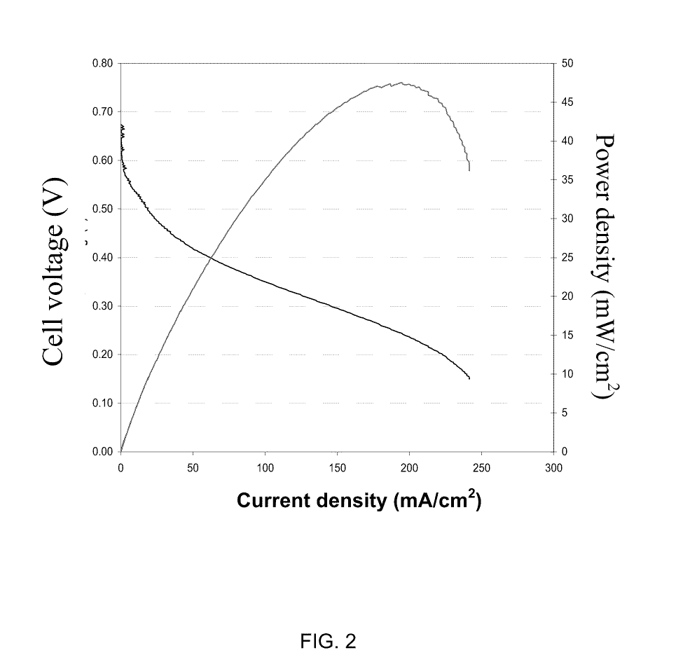

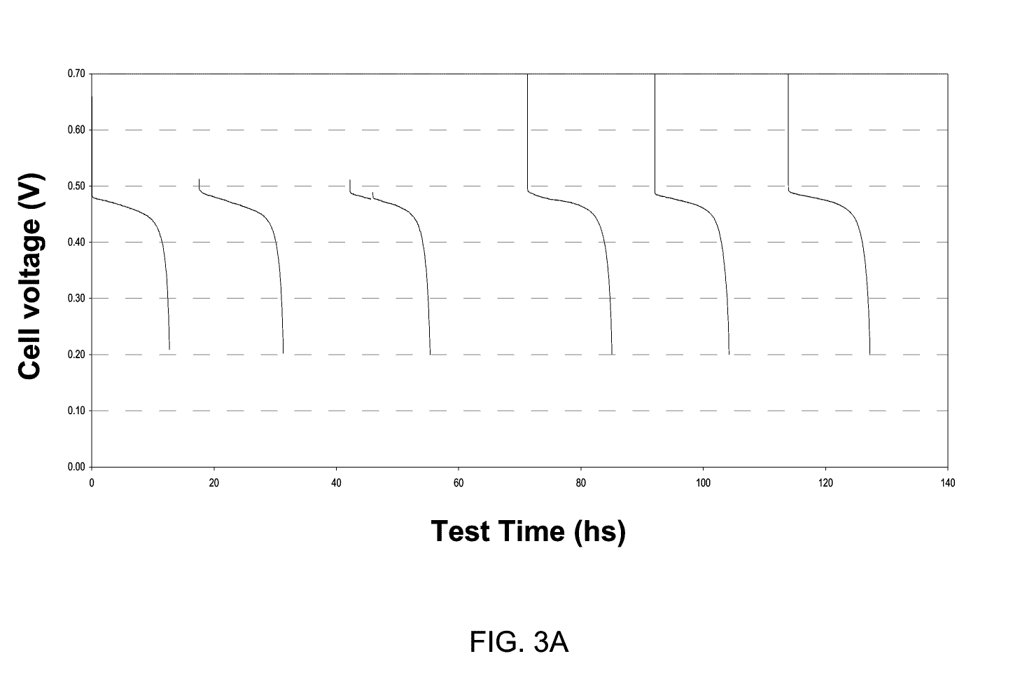

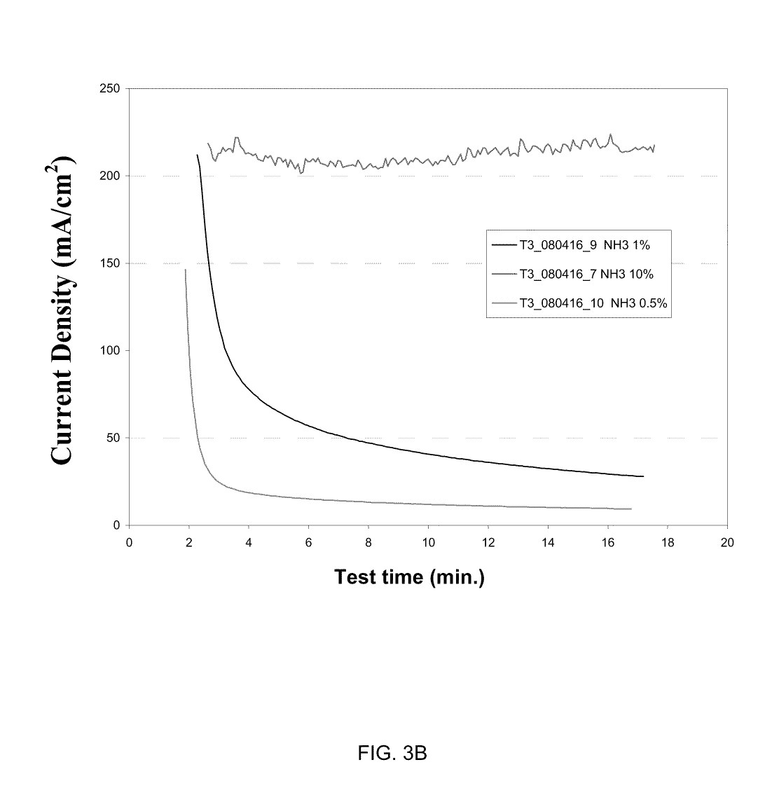

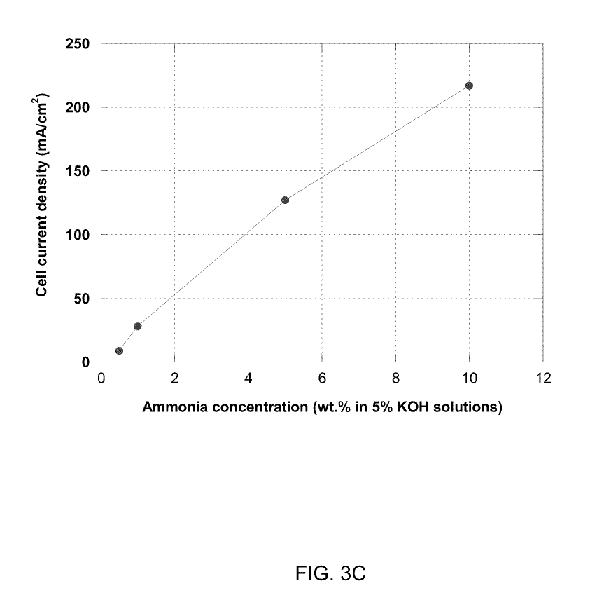

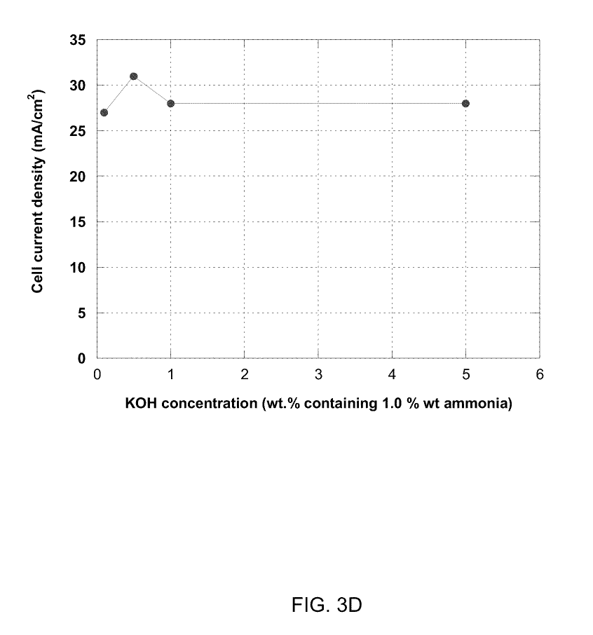

In FIG. 2, the cell voltage is plotted as the function of cell current density for a direct ammonia/air fuel cell operated at room temperature as illustrated in FIG. 1. The cell electrical power output is also plotted. FIG. 3A shows the cell voltage at a constant current discharge rate of 10 mA/cm². Renewed fuel returns the original fuel cell voltage after each run.

In the direct ammonia/air fuel cell, the ammonia molecules are converted to nitrogen gas at the cell anode as evidenced by the N₂ gas bubbles emerged, and the conversion rate is measured by the cell current density. As show by the cell voltage current curve in FIG. 2, the cell current density increases with the decrease in cell voltage. By directly shorting the anode and cathode to force the direct ammonia/air fuel cell operating at a zero cell voltage, the ammonia to nitrogen gas conversion reaction reaches the maximum rate. In such a case, all the chemical energy stored in the ammonia molecules is released as thermal energy without any electrical energy output.

To explore the ammonia electro-oxidation rate at near short circuit condition, a set of experiments were conducted with a direct ammonia/air fuel cell operated at room temperature with a cathode by oxygen diffusion from ambient air. FIG. 3B shows the cell current changes with time at a cell voltage of 0.05 V under various operating conditions. Steady state cell current densities at a cell voltage of 0.05 V were obtained after holding for 15 min.

A plot of the steady state cell current at 0.05 V as a function of ammonia concentration is shown in FIG. 3C for a direct ammonia/air fuel cell operated at room temperature with a cathode by diffusion from ambient air. Under the condition explored, the ammonia electro-oxidation rate at a concentration below 10 wt. % is clearly diffusion controlled as shown by the linear dependence of the cell current density on the ammonia concentration in the solution.

A plot of cell current at 0.05 V as a function of KOH concentration is shown in FIG. 3D for a direct ammonia/air fuel cell operated at room temperature with a cathode by diffusion from ambient air. Under the condition explored, the ammonia electro-oxidation rate is independent on the KOH concentration.

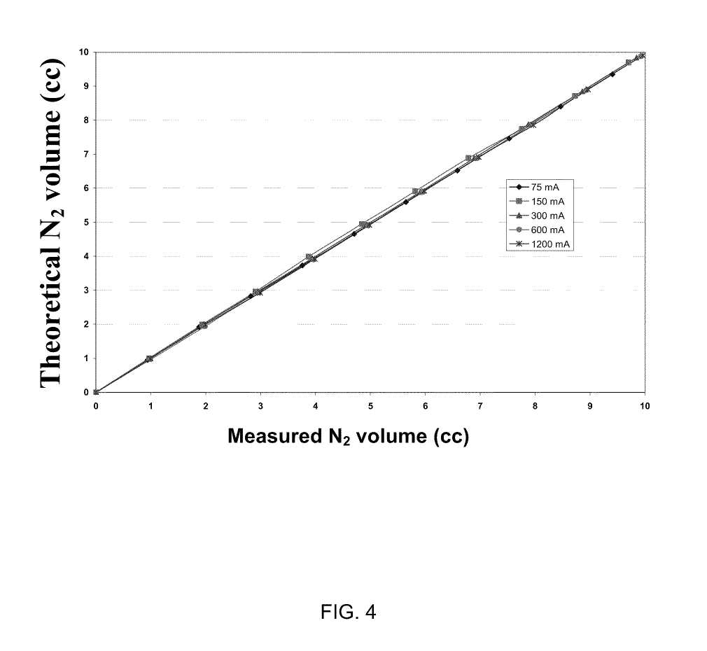

To verify that the ammonia conversion to nitrogen gas in the direct ammonia/air breathing fuel cell proceeds quantitatively according to the anodic electrode reaction eq. (1), the nitrogen gas bubbles emerging from the anode compartment were collected while holding the direct ammonia/air fuel cell at various constant current for a period of time. In FIG. 4, the gas volume generated from the anode is plotted against the N₂ gas volume calculated according to the Friday's law by following equation:

$${V}_{N 2} = \frac{R \cdot T \cdot I \cdot t}{96486 \cdot 6 \cdot ( {P}_{atm} - {P}_{w} )} \qquad ( 9 )$$

where:
V_{N2} (cc) is the theoretical N₂ volume;
I (mA) the constant current of the direct ammonia/air fuel cell;
t (sec) the period of time while the gas bubbles were collected;
Patm (atm) the atmosphere pressure;
Pw (atm) the water vapor pressure, assuming water vapor saturation in nitrogen gas;
T (° K.) the absolute temperature;
R (=0.08206 atm/(° K. mol)) the gas constant.

Table 1 summarizes the conversion efficiency of ammonia to nitrogen gas at the cell anode of a direct ammonia/air fuel cell determined by linear regression of the slope shown in FIG. 4. Within the experimental error, it is confirmed that ammonia to N₂ conversion in a direct ammonia/air fuel cell operated in a wide cell voltage range proceeds quantitatively at 100% efficiency.

TABLE 1
Ammonia to N₂ conversion efficiency in a direct ammonia/air
fuel cell operated at various current discharge rates
with the corresponding cell voltages.

| Current | Cell voltage | Ammonia to N₂ |
|---|---|---|
| mA | V | conversion efficiency |
| 75 | 0.401 | 100.20% |
| 150 | 0.368 | 98.40% |
| 300 | 0.323 | 99.50% |
| 600 | 0.253 | 101.30% |
| 1200 | 0.12 | 100.90% |

To assist the ammonia electro-oxidation electrode reaction eq. (1), various catalysts, such as Pt, or Pt based alloys, such as Ptlr, PtRu, PtRd, PtNi, have demonstrated to be effective. For oxygen-reduction electrode reaction eq. (7), Pt, Ni, Ag, graphite, Co-Tetramethoxyphenylporphrine, Fe—N-carbon, MnO₂ and TiO₂ etc have demonstrated to be effective. Usually, these catalysts are nanoparticles in size deposited on an electronically conductive support such as carbon, graphite, indium doped TiO₂, conducting polymer materials, tungsten oxides, metal powder, metal mesh and metal sheet materials etc.

In principle, one can use a direct ammonia/air fuel cell to convert ammonia in aqueous solution directly to nitrogen gas at ambient conditions. Compared to the prior art of using ammonia electrolysis, the approach of using direct ammonia/air fuel cell for the conversion process eliminates the need of an electrical energy input. However, there are other barriers shared with ammonia electrolysis method, such as the high cost associated with building electrodes, maintaining and running an electrochemical device, and the large electrode area required to achieve a reasonable ammonia conversion rate. These barriers could still be prohibitive for practical applications in lowering the ammonia level in an aqueous solution by a direct ammonia/air fuel cell.

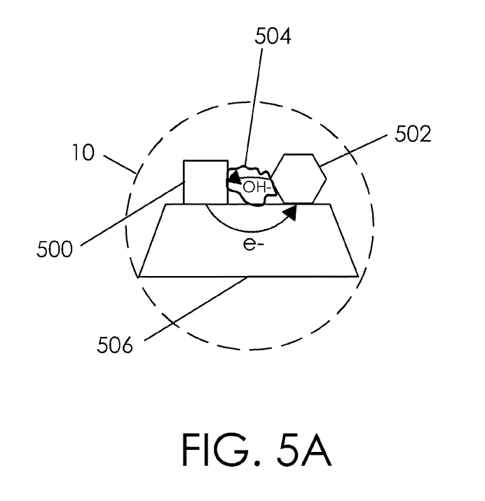

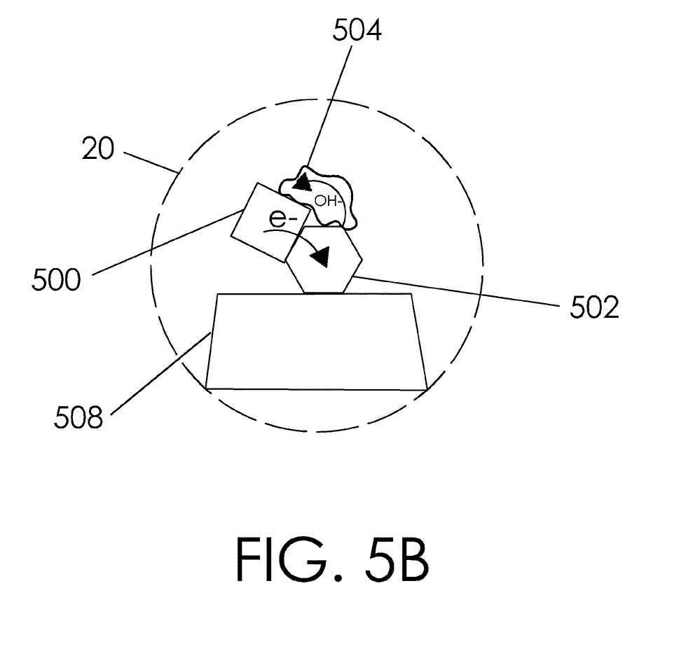

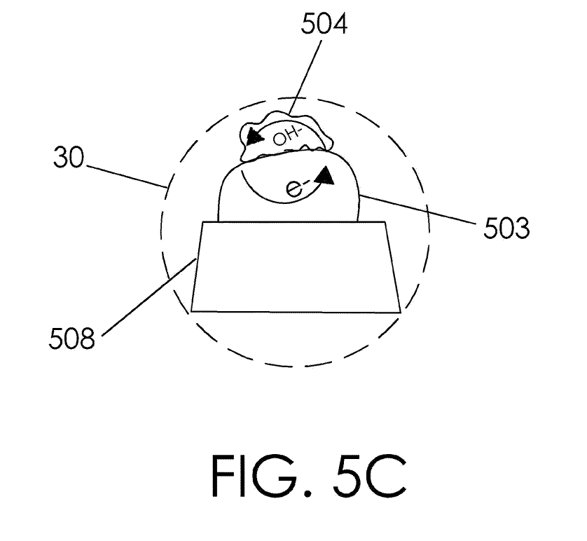

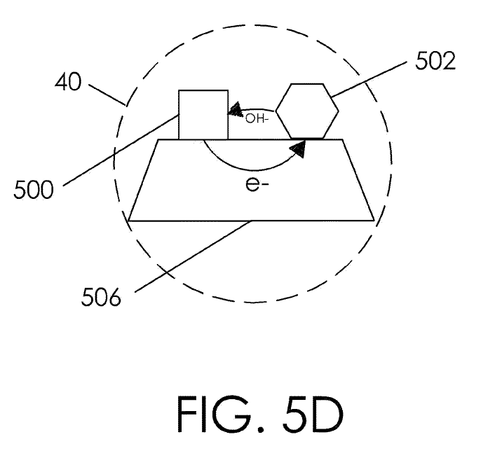

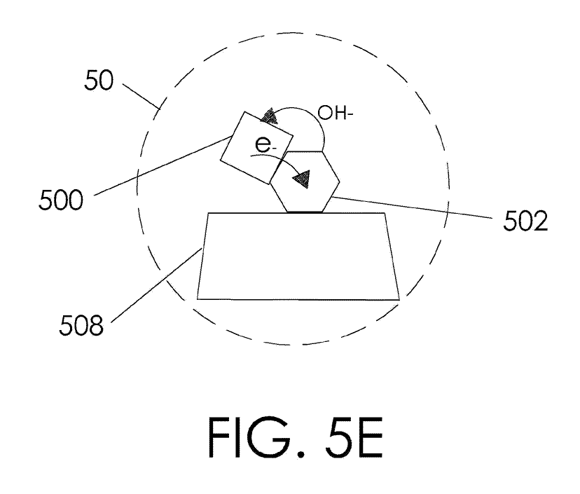

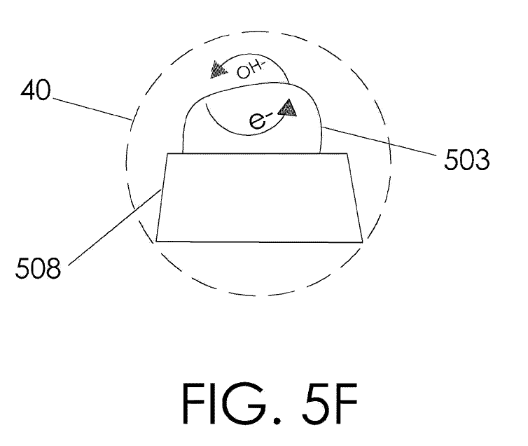

To overcome the remaining barriers of the high cost and large size of an electrochemical device, this invention builds a direct ammonia/air fuel cell at short circuit on a single catalyst particle as illustrated in FIG. 5A-F. In FIG. 5A, the catalyst particle 10 contains a type-A catalyst subparticle 500 and a type-B catalyst subparticle 502, both of which are attached to a surface of an electronically conductive support 506, and are connected by a hydroxyl ion conductive polymer coating layer 504. The type-A catalyst subparticle 500 is identical to the catalyst used in the anode of a direct ammonia/air fuel cell for electro-oxidizing ammonia to nitrogen gas, and the type-B catalyst subparticle 502 is identical to the catalyst used in the cathode of a direct ammonia/air fuel cell for electro-reducing oxygen to water.

With catalyst of this invention, the electrode reactions of a direct ammonia/air fuel cell operated in short circuit mode are carried out at a substantially miniaturized scale (a few nanometers) on the surface of a single catalyst particle 10, as illustrated in FIG. 5A, where ammonia and oxygen are fed together to reach the catalyst surface. The type-A catalyst subparticle 500 for ammonia electro-oxidation and type-B catalyst subparticle 502 for oxygen reduction are co-deposited on an electronically conductive support 506, such as carbon, graphitic carbon, nickel, and ITO etc. The type-A catalyst subparticle 500 facilitating the ammonia electro-oxidation reaction eq. (1) is directly shorted to the type-C catalyst subparticle 502 facilitating the oxygen reduction reaction eq. (7) by their common support 506 that is also electronically conductive.

Alternatively, as illustrated schematically in FIG. 5B, a catalyst 20 contains a type-A catalyst subparticle 500 forming direct contact with a neighboring type-C catalyst subparticle 502. In such a case, a non-electronically conductive support 510 can also be used, since now the electrons can pass from type-A catalyst subparticle 500 to type-C catalyst subparticle 502 at their contacts. The catalyst 20 can be formed, for example, by sequentially deposit type-C catalyst 502 on the support 510, and then deposit the type-A catalyst 500 on top of the type-C catalyst 502. Sometimes, the use of a non-electronically conductive support material, such as such as Al₂O₃, ZrO₂, TiO₂ etc, is desirable for their pore structure, enhanced chemical and mechanical stabilities, support enhancement for catalytic activities, and the block structure easily formed for use in a catalyst bed in a chemical reactor.

Alternatively, as illustrated schematically in FIG. 5C, the catalyst subparticles 503 such as Pt based catalysts on a catalyst particle 30 function simultaneously well for both ammonia electro-oxidation reaction and oxygen reduction reaction. Such a type-of catalyst subparticles 503 can be deposited on either electronically conductive support material 506 or on a non-electronically conductive support material 508. With catalyst subparticles 503 facilitating both electrode reactions, the electrode reactions eqs. (1) and (7) occur on the same surface of the catalyst subparticle 503, where part of the catalyst surface behaves as the type-A catalyst subparticle 500 and part as the type-C catalyst subparticle 502. Although catalyst subparticles 503 can be used for converting ammonia to nitrogen gas in aqueous phase, there are potentially several drawbacks. In order to accommodate the two electrode reactions eqs. (1) and (7), the size of the catalyst subparticle 503 need to be large enough to provide a catalytical surface sufficiently large to adsorb both ammonia and oxygen molecules. This inevitably decreases the fraction of catalyst atoms at the surface utilizable for the electrode reactions, and thus increases the catalyst cost. Additionally, compared to Pt, it has been reported that a Ptlr alloy catalyst has an order of magnitude higher activities for ammonia electro-oxidation to nitrogen, and a lower activity for oxygen electro-reduction to water. It is therefore more advantageous to separate these two activities to two types of catalysts. Additionally, non-precious metal based catalyst, such as graphite, compounds including N-containing compounds, pyrolytic products from transition metal-tetramethoxyphenylporphrine, Fe—N-carbon, transition metal oxide MnO₂, TiO₂ and Ag, possess a high oxygen reduction selectivity, and are available at a substantially lower cost than the noble metal based catalysts.

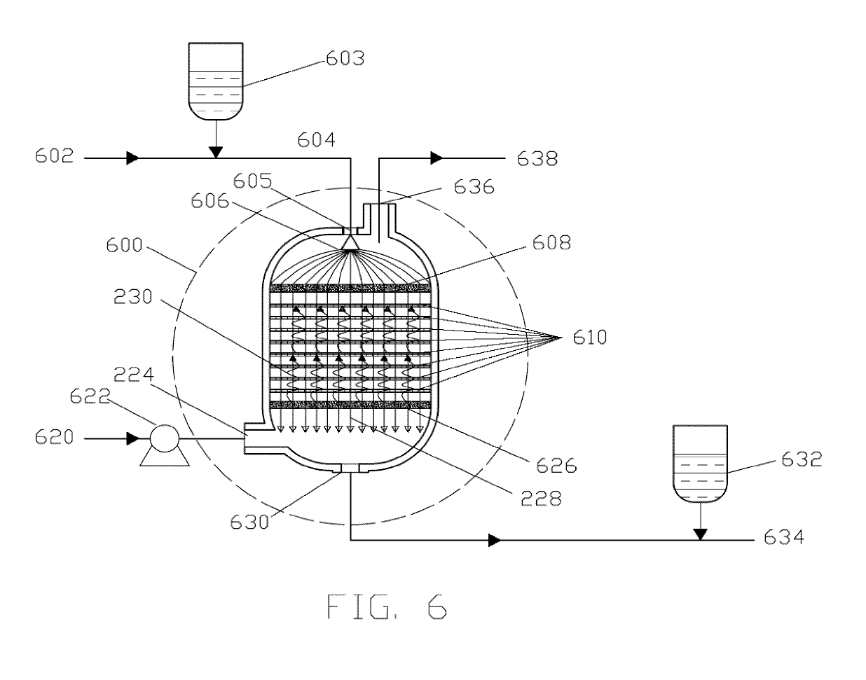

The two electrode reactions eqs. (1) and (7) are carried out by two adjacent catalyst subparticles on a single catalyst particle as illustrated in FIGS. 5A-B. Compared to the two electrodes in a direct ammonia/air fuel cell, the electronic and ionic conductances between the two neighboring catalyst subparticles are substantially enhanced because of the much diminished distance at nanoscale level between the two subparticles. Because of this nanoscale enhancement effects on the transport of OH⁻, the required conductance of OH⁻ to carry out the ammonia electro-oxidation and oxygen reduction at a reasonable rate is reduced. It is sufficient to carry out the ammonia conversion to N₂ gas in a much diluted alkaline solution because of the lowered OH⁻ conductivity requirement. The pH of a solution containing dissolved ammonia can reach a value up to 12, depending on the ammonia concentration. With the required OH⁻ conductance met in the aqueous solution at a pH between 7.5 and 13.0, the OH⁻ conductive polymer coating layer 504 on the catalyst particles 10, 20, and 30 is not needed, as illustrated in FIGS. 6A-C, for a catalyst particle 40, 50, and 60 without a OH⁻ conductive polymer coating layer, respectively. These catalysts are particularly useful for the applications of removal of ammonia in aqueous phase where the acceptable amount of alkaline content is low or the amount of base consumed for the treatment process need to be reduced.

A chemical reactor containing a plural of the catalyst particles equating multiple miniaturized direct ammonia/air fuel cells operated in short circuit mode will thus spontaneously convert ammonia molecules to nitrogen at the maximum reaction rate directly in aqueous phase. With the catalysts packed and confined in a catalyst bed in the reactor, the direct conversion of ammonia in an aqueous stream to nitrogen gas can be carried out continuously in a compact package, and without the high cost of constructing and maintaining an electrochemical device.

FIG. 6 is schematic block diagram showing one of many possible implementations of this invention in converting ammonia from an aqueous stream to nitrogen directly with a chemical reactor 600 containing the catalysts confined within catalyst beds 610. With such a chemical reactor, the initial cost of investment, the size of the device and the operating cost for water treatment for ammonia removal can be substantially reduced compared to the prior art documented technologies.

In FIG. 6, an aqueous stream 602 containing ammonia or ammonium (NH₄⁺) species is mixed with an alkaline solution 603, such as NaOH or other base, to raise the pH of the stream 604 to a value above 7.5. The stream 604 is then directed to a chemical reactor 600 through an input port 605 at the top of the reactor 600, and dispersed by a sprayer 606 over a porous frit plate 608. The droplets of the stream are dispersed and exposed to the catalyst particles confined within catalyst beds 610. Fresh air 620 is moved by a blower 622 into the reactor 600 through an air input port 224 located at the bottom of the reactor 600. The fresh air stream is distributed by a porous air distribution plate 626, and then exposed to the catalyst particles confined within the catalyst beds 610. Suitable arrangement of the catalysts within the catalyst beds 610 allows facile transport, mixing and distribution of the liquid droplets 228 flowing from the top to the bottom of the reactor 600 by gravity with the air flow 230, pushed up by the air blower 622, from the bottom to the top of the reactor 600. Ammonia reacts with oxygen from the air on the surface of the catalysts disposed in the catalyst beds 610 and is converted to nitrogen and water. The gas exhaust 638 containing nitrogen gas and used air is vented through a port 636. The treated aqueous solution is collected at the bottom of the reactor 600, and removed at an aqueous stream export port 630. If required, an acid solution 632, such as HCl or other acid, can be added to the outflow stream 634 to adjust it's pH to a predetermined value.

If desired, other oxidant such as pure oxygen, or hydrogen peroxide, air diluted with inert gas can be used.

If desired, the ammonia conversion to nitrogen can be carried at elevated pressure and temperature within the reactor. A higher temperature and pressure will speed up the conversion reaction, and thus reduce the size of the reactor required.

If desired, the ammonia in the waste stream can be collected and enriched by standard cation exchanger column before being introduced to a reactor for conversion to nitrogen.

### Example 1

In this example, a catalyst was made by pyrolizing a precursor of Fe-phthalocyanine deposited on a high surface area carbon.

In a 2 L beaker, a batch of 40 grams of Ketjen Black EC300J carbon powder was added, flowed by adding 1.5 L ethanol and 20 grams of Fe-phthalocyanine. The mixture was stirred for 30 min, followed by intense pulses of sonication with ultrasonic probe for 30 min. The mixture was stirred overnight. After that, the solvent is removed using a rotary evaporator at 60° C. to obtain the precursor of Fe-phthalocyanine deposited on the carbon powder. The precursor was then transferred to a quartz reactor for the pyrolytic treatment. The quartz reactor was placed inside a furnace equipped with a programmable temperature controller. The pyrolysis was carried out under argon flow at 100 SCCM. The reactor was ramped to 150° C. over a period of 15 min. and held at 150° C. for 20 min., then ramped to 445° C. over a period of 30 min. and held at 445° C. for one hour, then ramped to 785° C. over a period of 45 min and held at 785° C. for two hours, and then cooled to room temperature by natural heat dissipation. The pyrolic product was collected and ball milled. Elemental analysis by ICP showed that the catalyst contained 4.2 wt. % Fe. This catalyst is designated as FeNC/C.

### Example 2

In this example, a Ptlr catalyst was made by incipient wetness method to distribute Pt and Ir ionic species from solution to a high surface area carbon, followed by reduction in the gas phase.

In a 250 mL beaker, 0.7 grams of IrCl₃.3H₂O and 1.2 grams of H₂PtCl₆ were added. A 20 mL of water and methanol mixture at 50/50 volume ratio was then added. Part of the resulting solution was added to a 2 L beaker containing 20 grams of Ketjen Black EC300J carbon powder to form a paste at incipient wetness. The paste was stirred and pressed with a spatchula, and dried at room temperature for about 90 minutes, followed by drying under vacuum (0.5 torr (65 Pa), 60° C.) for about 2.5 hours. The powder mixture was then transferred to quartz reactor for reduction treatment. The reduction was carried out under a reforming gas (95% N₂, 5% H₂) flow at 100 SCCM. The reactor is ramped to 100° C. over a period of 15 min and held at 100° C. for 20 min., then ramped to 255° C. over a period of 30 min and held at 255° C. for 30 min, and then cooled to room temperature by natural heat dissipation. The reduced product was collected and ball milled. Elemental analysis by ICP showed that the catalyst contained 1.9 wt. % Ir and 2.7 wt. % Pt. This catalyst was designated as Ptlr/C-support.

### Example 3

In this example, a Ptlr catalyst was made by incipient wetness method to distribute Pt and Ir ionic species from solution to the FeNC/C-support catalyst formed in Example 1, followed by reduction in the gas phase.

In a 250 mL beaker, 0.7 grams of IrCl₃.3H₂o and 1.2 grams of H₂PtCl₆ were added. A 50 mL of water and methanol mixture at 50/50 volume ratio was then added. Part of the resulting solution was added to a 2 L beaker containing 20 grams of the catalyst FeNC/C to form a paste at incipient wetness. The paste was stirred and compressed with a spatchula, and dried at room temperature for about 90 minutes, followed by drying under vacuum (0.5 torr (65 Pa), 60° C.) for about 2.5 hours. The powder mixture was then transferred to quartz reactor for reduction treatment. The reduction was carried out under a reforming gas (95% N₂, 5% H₂) flow at 100 SCCM. The reactor is ramped to 100° C. over a period of 15 min and held at 100° C. for 20 min., then ramped to 255° C. over a period of 30 min and held at 255° C. for 30 min, and then cooled to room temperature by natural heat dissipation. The reduced product was collected and ball milled. Elemental analysis by ICP showed that the catalyst contained 4.2 wt % Fe, 1.9 wt. % Ir and 2.7 wt. % Pt. This catalyst was designated as Ptlr/FeNC/C-support.

### Example 4

In this example, the three catalysts prepared in examples 1-3 and the Ketjen Black EC300J carbon support were tested for oxidation of ammonia in aqueous solution.

An ammonia solution containing 250 ppm ammonia was prepared. The solution had a pH value of 10.698, measured using an Orion 230A digital pH meter with a 9107BN pH electrode. The measured pH value was in good agreement with the value from equilibrium calculation of ammonia dissociation in water at room temperature. A batch of 15 grams of catalyst sample was loaded in a glass chromatography column with a fritted disc (10 μm pore diameter) at column bottom and a reservoir at column top. A 15 cc ammonia solution containing 250 ppm ammonia was added to the column. An oxygen flow pre-saturated with water at room temperature was introduced at the bottom of the column. After the initial steady state of flow of oxygen through the column was achieved, the oxygen flow rate was held steady at 4 SCCM. After a period of 30 min, the oxygen flow was stopped, and the ammonia solution was extracted by vacuum from the column into a filtering flask. The pH of the treated solution was measured to determining the remaining ammonia concentration. Table 2 summarizes the test results for the three catalyst samples plus the Ketjen Black EC300J carbon support sample. The test results showed that the carbon support and FeNC/C-support are not effective in oxidizing ammonia for its removal. As expected, the FeNC/C-support catalyst contains only type-C catalyst subparticles useful for the oxygen reduction reaction. The Ptlr/C-support catalyst works well since the Ptlr catalyst subparticles can function as both type-A catalyst subparticles for ammonia oxidation, and type-C catalyst subparticles for oxygen reduction. The best performance is achieved with the Ptlr/FeNC/C-support catalyst, which contains the high performance Ptlr as type-A catalyst subparticles for ammonia oxidation, and the FeNC as type-C catalyst subparticles for oxygen reduction.

These examples are no by means in limiting the scope of this patent in performance and applications. It is expected that a better performance can be achieved with a better reactor design for improved gas/liquid distribution within the catalyst column, at a higher operating temperature, and with optimizations of other contributing factors.

TABLE 2
Test results of ammonia removal from an aqueous ammonia solution
containing a starting ammonia concentration at 250 ppm by three
types of catalysts and a carbon support at room temperature.

| | Solution pH | NH₃ concentration | Percentage |
|---|---|---|---|
| | at end of | at end of treatment | of ammonia |
| Catalysts | treatment | (ppm) | removed |
| PtIr/FeNC/C-support | 10.291 | 40 | 84% |
| PtIr/C-support | 10.584 | 147 | 41% |
| FeNC/C-support | 10.688 | 235 | 6% |
| C-support | 10.692 | 240 | 4% |

In view of the disclosure presented herein, yet other modifications and variations of the invention will be apparent to those of skill in the art. The foregoing discussion, description and examples are illustrative of specific embodiments of the invention, but they are not meant to be limitations upon the practice thereof. It is the following claims, including all equivalents, which define the scope of the invention.

What is claimed and desired to be secured by United States Letters Patent is:

1. A catalyst for converting ammonia directly in an aqueous solution into nitrogen gas, comprising:
(a) a type-A catalyst subparticles for oxidizing ammonia to nitrogen gas;
(b) a type-C catalyst subparticles for reducing oxygen to water; and
(c) said type-A catalyst subparticles directly contact with said type-C catalyst subparticles at neighboring locations,
thereof, the electrons extracted from oxidizing ammonia to nitrogen gas at said type-A catalyst subparticles are passed to said type-C catalyst subparticles for oxygen reduction to water, and both reactions at said type-A catalyst subparticles and said type-C catalyst subparticles are capable to proceed spontaneously at near ambient conditions.

2. The catalyst of claim 1, further including a hydroxide anion exchanging polymer electrolyte coating layer for conducting hydroxide anion between said type-A catalyst subparticles and said type-C catalyst subparticles at neighboring locations.

3. The catalyst of claim 1, further including a support material selected from carbon powder, graphitic carbon power, carbon nanotubes, fullerene, refractory metal oxides, silica, zeolites, transition metal carbide, transition metal nitride, metal powder, metal mesh and metal sheet materials.

4. The catalyst of claim 1, wherein said type-A catalyst subparticles for oxidizing ammonia in an aqueous solution to nitrogen are made from a group of elements including Pt, Ru, Ir, Rh, Ni, Pd, Cr, Mo, Au, W, V, Fe, Co, Cu, Mn, Zn, Mg, Na, K, Cs, Ca, Ge, Sn, Bi, Ti, Ag, Nb and Zr.

5. The catalyst of claim 1, wherein said type-C catalyst subparticles for reduction of oxygen to water are made from a group of elements including Pt, Ru, Ir, Rh, Ni, Pd, Cr, Mo, Au, W, V, Fe, Co, C, and Ag, and from compounds including graphite, N-containing compounds, pyrolytic products from transitional metal-tetramethoxyphenylporphrine, transitional metal-phthalocyanine, transitional metal-N-carbon, and transitional metal oxide including MnO₂ and TiO₂.

6. The catalyst of claim 1, wherein said type-A catalyst subparticles for oxidizing ammonia in an aqueous solution to nitrogen are made from Pt based alloy including Ptlr and PtRu, and said type-C catalyst subparticles for reduction of oxygen to water are made from pyrolytic products from transition metal-tetramethoxyphenylporphrine, and said type-A catalyst subparticles are deposited from a source containing Pt and other alloy elements on top of said type-C catalyst subparticles.

7. A catalyst for converting ammonia directly in an aqueous solution into nitrogen gas, comprising:
(a) a type-A catalyst subparticles for oxidizing ammonia to nitrogen gas;
(b) a type-C catalyst subparticles for reducing oxygen to water; and
(c) an electronically conductive support forming direct contacts with said type-A catalyst subparticles and with said type-C catalyst subparticles,
thereof, the electrons extracted from oxidizing ammonia to nitrogen gas at said type-A catalyst subparticles are passed through said electronically conductive support to said type-C catalyst subparticles for oxygen reduction to water, and both reactions at said type-A catalyst subparticles and said type-C catalyst subparticles are capable to proceed spontaneously at near ambient conditions.

8. The catalyst of claim 7, further including a hydroxide anion exchanging polymer electrolyte coating layer for conducting hydroxide anion between said type-A catalyst subparticles and said type-C catalyst subparticles at neighboring locations.

9. The catalyst of claim 7, wherein said type-A catalyst subparticles for oxidizing ammonia in an aqueous solution to nitrogen are made from a group of elements including Pt, Ru, Ir, Rh, Ni, Pd, Cr, Mo, Au, W, V, Fe, Co, Cu, Mn, Zn, Mg, Na, K, Cs, Ca, Ge, Sn, Bi, Ti, Ag, Nb, and Zr.

10. The catalyst of claim 7, wherein said type-C catalyst subparticles for reduction of oxygen to water are made from a group of elements including Pt, Ru, Ir, Rh, Ni, Pd, Cr, Mo, Au, W, V, Fe, Co, C, and Ag, and from compounds including graphite, N-containing compounds, pyrolytic products from transitional metal-tetramethoxyphenylporphrine, transitional metal-phthalocyanine, transitional metal-N-carbon, and transitional metal oxide including MnO₂ and TiO₂.

11. The catalyst of claim 7, wherein said type-A catalyst subparticles for oxidizing ammonia in an aqueous solution to nitrogen are made from Pt based alloy including Ptlr and PtRu, and said type-C catalyst subparticles for reduction of oxygen to water are made from pyrolytic products from transition metal-tetramethoxyphenylporphrine, and said support is made of carbon powder. thereof, said type-C catalyst subparticles forms a coating layer on said support, and said type-A catalyst subparticles are deposited from a source containing Pt and other alloy elements on top of said type-C catalyst subparticles.

12. A chemical reactor for converting ammonia in an aqueous stream to nitrogen gas comprising of:
(a) a reactor body having at least one port for receiving an aqueous stream containing ammonia and a stream containing oxidant, and at least one port for exporting a stream containing nitrogen gas produced from the conversion reaction;
(b) a catalyst bed within said reactor body; and
(c) catalysts confined within said catalyst bed for facilitating the oxidization of ammonia to nitrogen gas and reduction of oxygen to water, wherein each said catalyst particle contains a type-A catalyst subparticles for oxidizing ammonia in aqueous phase to nitrogen gas, and a type-C catalyst subparticles for reducing oxidant to water.
thereof, said ammonia containing steam is mixed with said oxidant containing stream and exposed to said catalysts, and ammonia is converted directly in aqueous phase to nitrogen gas within said reactor in a continuous mode of operation.

13. The catalysts of claim 12, wherein said type-A catalyst subparticles are made from a group of elements including Pt, Ru, Ir, Rh, Ni, Pd, Cr, Mo, Au, W, V, Fe, Co, Cu, Mn, Zn, Mg, Na, K, Cs, Ca, Ge, Sn, Bi, Ti, Ag, Nb, and Zr.

14. The catalysts of claim 12, wherein said type-C catalyst subparticles are made from a group of elements including Pt, Ru, Ir, Rh, Ni, Pd, Cr, Mo, Au, W, V, Fe, Co, C, and Ag, and from compounds including graphite, N-containing compounds, pyrolytic products from transitional metal-tetramethoxyphenylporphrine, transitional metal-phthalocyanine, transitional metal-N-carbon, and transitional metal oxide including MnO₂ and TiO₂.

15. The catalysts of claim 12, further including a support material selected from carbon powder, graphite carbon powder, carbon nanotubes, fullerene, transition metal carbide, transition metal nitride, metal powder, metal mesh and metal sheet materials.

16. The chemical reactor of claim 12, wherein said oxidant includes air, O₂, ozone, NOₓ, and hydrogen peroxide.

17. The chemical reactor of claim 12, wherein said reactor is operated with air or oxygen containing gas stream at a range of temperature, from ambient to 150° C., and a pressure from ambient to the autoclave pressure up to 10 bars.

18. The chemical reactor of claim 12, wherein said aqueous stream containing ammonia in said chemical reactor has a pH value ranging from 7.5 to 14.0.

19. The catalysts of claim 12, wherein said catalysts are made from platinum, and platinum containing alloys.
